(19) United States
(12) Patent Application Publication
(10) Pub. No.: US 2004/0154870 A1
(43) Pub. Date: Aug. 12, 2004

(54) Self-climbing elevator machine comprising a punched rail assembly

(76) Inventors: Patrick Bass, Lakeside, CA (US); John W. Koshak, Ramona, CA (US); Aranggi Soemardjan, El Cajon, CA (US)

Correspondence Address: WHITE & CASE LLP, PATENT DEPARTMENT, 1155 AVENUE OF THE AMERICAS, NEW YORK, NY, 10036, US

(21) Appl. No.: 10/622,858

(22) Filed: Jul. 18, 2003

Related U.S. Application Data
(63) Continuation-in-part of application No. 10/353,173, filed on Jan. 28, 2003.

(51) Int. Cl. B66B 9/02; B66B 7/02

(52) U.S. Cl. 187/270; 187/406

(57) ABSTRACT

A mechanical system and method for constructing a self-supporting, elevator support structure and a traction (rope-operated) elevator system comprising such a support structure. A rail-climbing platform is used to progressively erect higher levels of modular rail sections and other components of the system without the need for external props such as a scaffold.

### CROSS REFERENCE TO RELATED APPLICATIONS

This application is a continuation-in-part of application Ser. No. 10/353,173, filed Jan. 28, 2003, the contents of which are incorporated by reference in their entirety.

### FIELD OF INVENTION

The present invention is directed to the field of elevators and lifting systems. More specifically, the present invention is directed to apparatus and systems for installation of traction elevators in a building without the need for scaffolding.

### BACKGROUND OF THE INVENTION

In constructing traction-type elevator systems within the confines of a building, an installer typically must first construct scaffolding within the hoistway, and then use the existing structure of the building as a support to lift elevator components up through the hoistway to higher levels of the structure. Such methods of installation can place significant loads on the structure of the building and require costly and time-consuming construction and removal of the scaffolding. It is therefore desirable to have an apparatus and system for installation of a traction-type elevator system, from the foundation level up to higher levels, which do not require construction of scaffolding within the hoistway, and which do not require the use of the structure of the building, i.e., above the foundation on which the elevator system is constructed, for support.

### SUMMARY OF THE INVENTION

The present invention provides a mechanical system and method for constructing a self-supporting elevator support structure, and a traction (rope-operated) elevator system comprising such a support structure. A feature of the present invention is the use of a rail-climbing platform to progressively erect higher levels of modular rail sections and other components of the system without the need for external props such as scaffolding. Once completed, the elevator may be used as a passenger elevator, freight elevator, or for mixed use.

In one aspect of the claimed invention, a work structure for constructing a modular elevator support structure for an elevator system is provided. The work structure comprises a pit channel module; a plurality of vertical modular guide rails; and a platform slidably coupled to the preselected guide rail and connected to a motor drive having a gear. One end of each guide rail is attached to the pit channel module, and the other end is connectable in an end-to-end manner with additional guide rails or to a header module. At least one preselected modular guide rail has a plurality of holes linearly aligned along its longitudinal axis. The gear has teeth which are sized and configured to engage with the holes of the preselected guide rail. Operating the motor drive causes the teeth of the gear to engage the holes of the preselected guide rail and thereby raise or lower the platform along the vertical guide rails.

The work structure permits the construction of an elevator support structure (and ultimately an elevator system) having any particular height or number of floors. The work structure or the support structure may be installed permanently in a given location. The work or support structure may be also be installed on a temporary basis, for example, until a permanent elevator can be installed at the desired site. The work or support structures can be used for light-duty or heavy-duty elevator use.

In any of the embodiments of the invention, the holes of the preselected guide rail may be formed directly in the body of the rail, or may be formed initially on a separate longitudinal rail which is then fastened or affixed to the preselected guide rail.

The work structure may comprise means for maintaining the gear in engagement with the holes of the preselected guide rail. For example, a device or mechanical arrangement may be present in the structure for preventing the gear and the guide rail from moving too far apart or too close to each other.

The modular guide rails used to erect the work or support structure may be counterweight guide rails, elevator car guide rails, or combinations thereof.

In another aspect of the claimed invention, a modular elevator support structure is provided. The modular elevator support structure comprises a pit channel module; a header module; and a plurality of vertical guide rails, each guide rail comprising at least two end-to-end modular sections. A lower end of each of a first subset of the plurality of guide rails is attached to the pit channel module, and another end of each of a second subset of the plurality of guide rails is attached to the header module. At least one preselected guide rail has holes aligned along its longitudinal axis. The first subset of guide rails may be the lowest rails in the structure, and the second subset of guide rails may be the highest rails in the structure.

The modular elevator support structure may further comprise a platform slidably coupled to at least one guide rail and connected to a motor drive having a gear. The gear has teeth which are sized and configured to engage with the holes of the preselected guide rail. Operating the motor drive causes the teeth of the gear to engage the holes of the preselected guide rail and to thereby raise or lower the platform along the vertical guide rail. The ability of the platform to be raised and lowered permits an elevator installer to erect guide rails or other components of the elevator system at higher floor levels, and thereby construct an elevator having any number of levels.

The support structure may comprise at least one horizontally-oriented bracket attached to at least two neighboring vertical guide rails in order to provide further stability to the structure.

In one embodiment of the invention, the support structure is configurable to support a traction elevator. In such an embodiment, the plurality of vertical guide rails may comprise at least two counterweight guide rails and at least two elevator car guide rails. However, any combination of car guide rails and counterweight guide rails is possible, and the guide rails do not need to be any particular height or each have a uniform height. The materials of construction are not critical, so long as they can support the weight and function of the elevator and provide stability to the structure.

The preselected guide rail having holes may be a counterweight guide rail or an elevator car guide rail. Alternatively, the preselected guide rail may be any type of rail located in or near an elevator hoistway which assists the functioning of the elevator.

The support structure may further comprise means for maintaining the gear in engagement with the holes of the preselected guide rail during construction. Such means may be any device or mechanism which maintains the gear and the guide rail in a certain orientation, or which maintains a particular distance between the gear and rail.

According to another aspect of the claimed invention, a method of erecting an elevator support structure for a traction elevator system is provided. The method comprises the steps of:

providing a pit channel module on a foundation;

providing a plurality of modular guide rail sections, each guide rail section having two ends;

connecting the first end of each of a preselected number of guide rail sections to the pit channel module to form a first level of guide rail sections, the second end of each of the predetermined number of guide rail sections being connectable in an end-to-end manner with additional guide rail sections, wherein at least one preselected guide rail section of the first level has a plurality of holes aligned along its longitudinal axis;

slidably coupling a platform to at least one guide rail section, and connecting the platform to a motor drive having a gear, the gear sized and configured to engage with the holes of the preselected guide rail section;

operating the motor drive to engage the holes of the preselected guide rail section and thereby causing the platform to be raised or lowered along the guide rail section; and

installing a header module or additional guide rail sections to form an additional level of guide rail sections.

The additional level of guide rail sections may further comprise at least one additional preselected rail section having holes for progressively raising the platform for installation of at least one subsequent level of guide rails or the header module. Therefore, through the installation of additional preselected guide rails and rail sections, the elevator support structure may be constructed to be any particular height.

According to another aspect of the claimed invention, there is provided a method of erecting a rope-driven elevator system. The method comprises the steps of:

providing a pit channel module on a foundation;

providing a plurality of modular guide rail sections, each guide rail section having two ends;

connecting the first end of the plurality of guide rail sections to the pit channel module to form a first level of guide rail sections, the second end of each of the guide rail sections being connectable in an end-to-end manner with additional guide rail sections, wherein at least one preselected guide rail section of the first level has a plurality of holes aligned along its longitudinal axis;

slidably coupling a platform to at least one guide rail section, and connecting the platform to a first motor drive having a gear, the gear sized and configured to engage with the holes of the preselected guide rail section;

operating the first motor drive to engage the holes of the preselected guide rail section and thereby causing the platform to be raised or lowered along the guide rail section;

installing at least one additional level of guide rail sections and the header module to form an elevator support structure;

securing a second motor drive to the elevator support structure or to the foundation, the second motor drive having a support rope-engagement drive member;

installing an elevator car, an elevator support rope and an elevator counterweight in the elevator support structure in an operably linked manner with the support rope-engagement member such that the car and counterweight are vertically displaceable within the elevator support structure by operation of the second motor drive.

The method according to the invention allows the construction of a tractor elevator system of any particular height within an elevator shaft. In certain embodiments, the traction elevator may be built outside an elevator hoistway, for example, adjacent to an existing building or structure.

In the claimed method, the first motor drive and the second motor drive may be the same or different. The elevator system may also comprise means for maintaining the gear in engagement with the holes of the preselected guide rail section during installation.

The work structure of the invention can be readily converted into the elevator support structure by removing the work components, such as the platform, and installing the other elevator components, such as the car, counterweight, motor drive, and header module.

### BRIEF DESCRIPTION OF DRAWINGS

FIG. 1 illustrates a modular, self-climbing elevator system according to an embodiment of the present invention for the construction of a traction elevator system.

FIG. 2 is a close-up view of the self-climbing mechanism of the embodiment illustrated in FIG. 1, showing the engagement of the counterweight guide rail and the drive gear.

FIG. 3 shows an alternative view of the self-climbing mechanism illustrated in FIG. 2.

FIG. 4 illustrates a one-piece C-shaped rail according to an embodiment of the present invention, the rail having holes for engagement with a drive gear and attachment to a counterweight guide rail.

FIG. 5 is a sectional, close-up view of the C-shaped rail shown in FIG. 4.

FIG. 6 is a sectional, perspective view of the C-shaped rail shown in FIG. 4.

FIGS. 7 and 8 illustrate a C-shaped rail according to a different embodiment of the invention than the one illustrated in FIGS. 4-6, wherein the rail is formed from two separate components fastened together.

FIG. 9 is a perspective view of the rail illustrated in FIGS. 7 and 8.

FIG. 10 illustrates a motor drive and self-climbing mechanism of an elevator system assembled for self-climbing mode, according to an embodiment of the invention.

FIG. 11 is a rear view of the motor drive and self-climbing mechanism illustrated in FIG. 10.

FIG. 12 is a close-up view of an embodiment of the self-climbing drive mechanism during self-climbing mode, wherein a restrictor pad assemblage is used to prevent disengagement of the drive gear from the engagement holes of the guide rail.

FIG. 13 illustrates an embodiment of the invention, wherein a temporary platform and the motor drive of the elevator system are raised above the initial assembly position by self-climbing.

FIG. 14 illustrates the elevator support structure of FIG. 13 at the completion of self-climbing assembly mode, with the motor drive mounted to the pit channel module, and the temporary platform replaced by an elevator sling positioned near the foundation of a building.

FIG. 15. illustrates the elevator support structure of FIG. 14, with the elevator sling positioned at a higher floor level.

### DETAILED DESCRIPTION

The structure of present invention will now be described with reference to the figures, wherein like numerals correspond to like elements.

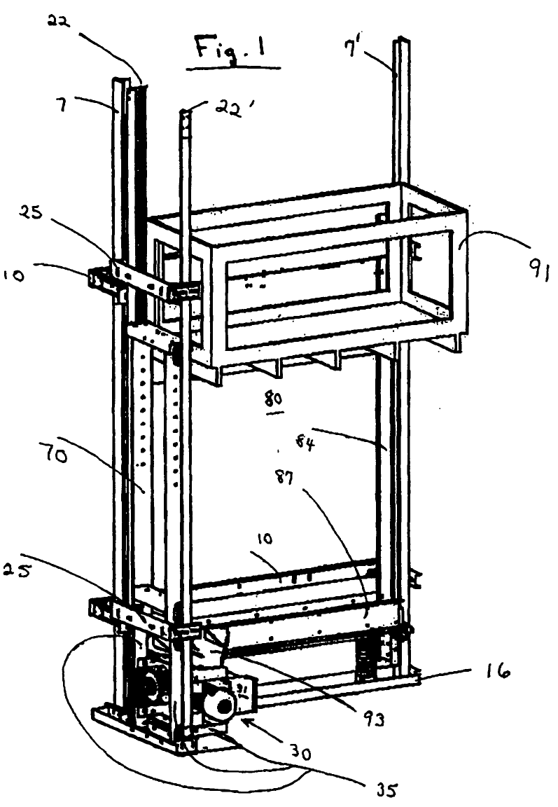

FIG. 1 shows a partially constructed traction elevator according to an embodiment of the invention, in which a self-climbing elevator machine climbs a punched rail and provides for construction of a traction type elevator from the pit up. At the beginning of the installation, a pit channel module 16 is installed at the bottom of a hoistway. The pit channel module comprises the structural supports, beams, and other elements necessary for providing a firm footing for the elevator system on the foundation. Car guide rails 7 and 7′ are affixed to one or more car guide rail brackets 10. The lowest car guide rail bracket 10 is located a few feet above the pit channel module 16, and the next rail car guide rail bracket is located approximately ten feet above the first. Two counterweight guide rail sections 22 and 22′ are connected to the pit channel module. In this embodiment, the counterweight guide rail sections 22 and 22′ and the car guide rail sections 7 and 7′ are all uniform in length and are approximately sixteen feet long. The counterweight guide rails 22 and 22′ are connected by counterweight guide rail brackets 25. The counterweight guide rail brackets 25 and the car guide rail bracket 10 can optionally be affixed to the building at one or more points to provide additional lateral stability.

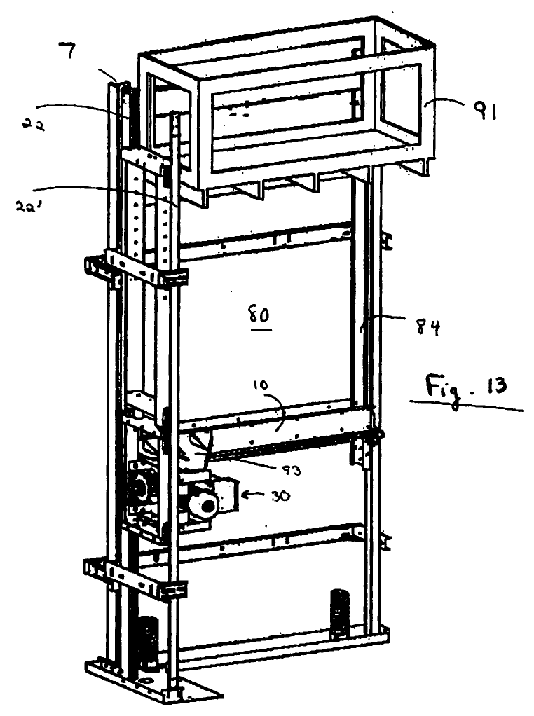

In FIG. 1, a car sling 80 comprises two stiles 84 (only one visible) and upper and lower bolsters 87 (the upper bolster obscured by the temporary platform 91). The stiles 84 slide along car guide rails 7 and 7′. A machine mount tool plate bracket 93 (also shown in FIG. 11) attaches the lower bolster 87 to the machine 30. A temporary platform 91 is mounted to the upper bolster and consequently rises and falls as the machine 30 climbs up and down the guide rails.

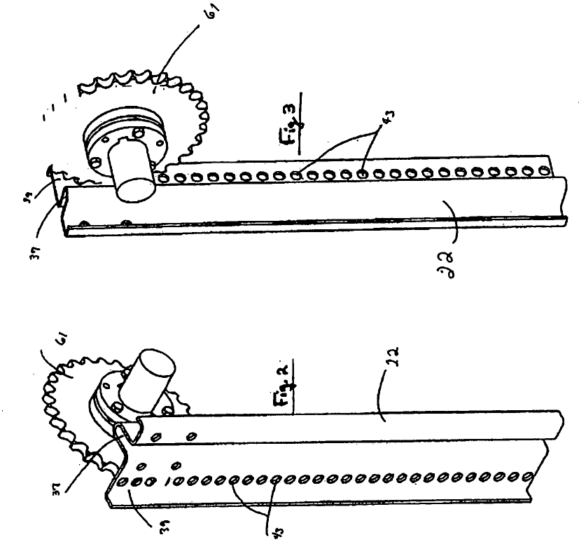

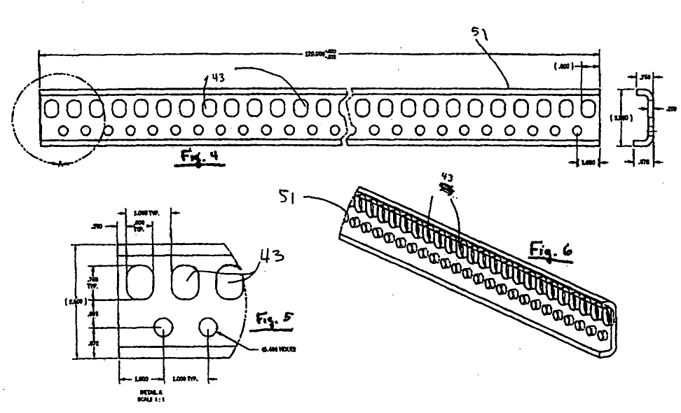

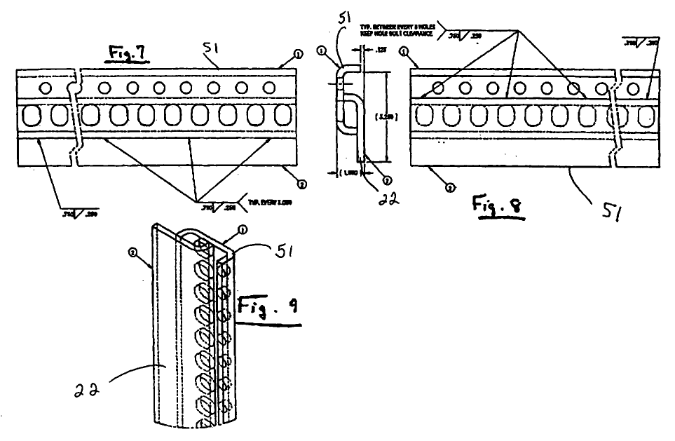

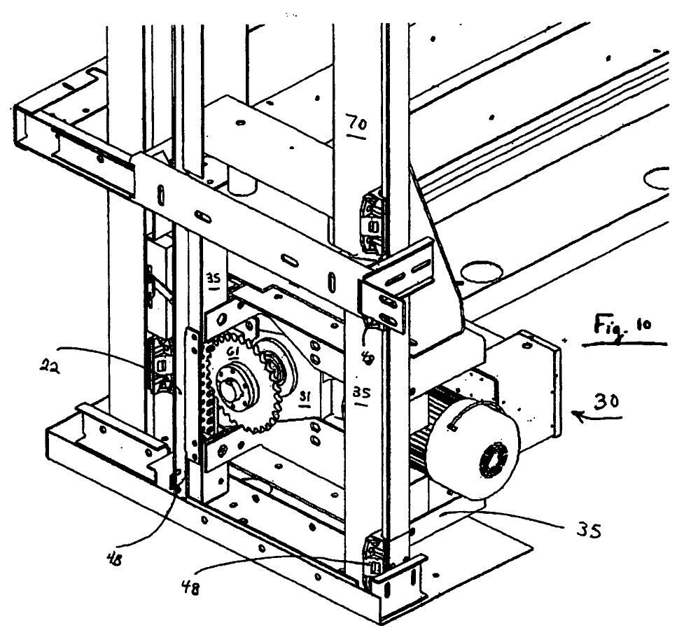

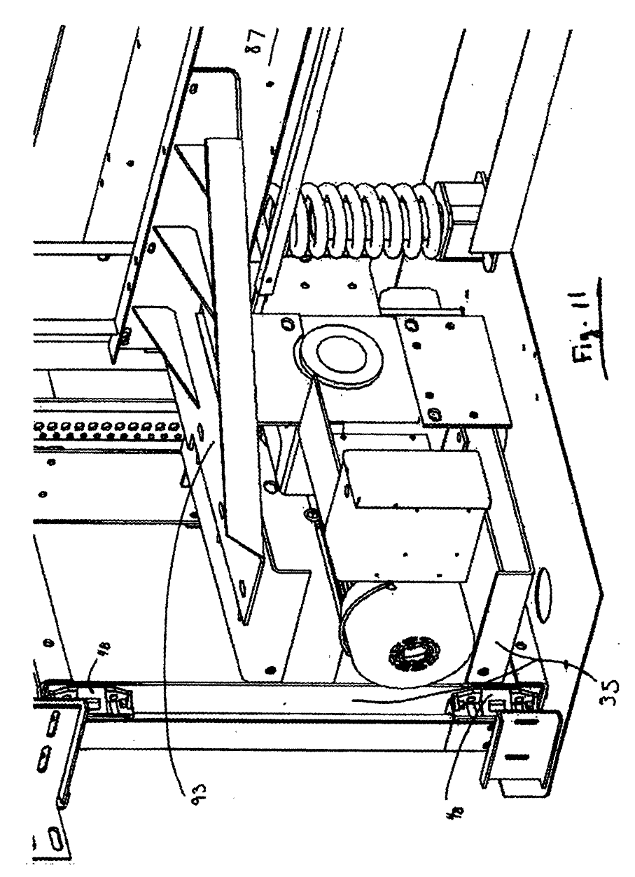

According to one embodiment the invention, counterweight guide rail 22 has a special construction, an example of which is shown in greater detail in FIGS. 2 and 3. Counterweight guide rail 22 has a guide portion 37 and a portion 39 in which a series of linearly-aligned holes 43 have been formed. The linearly-aligned hole portion 39 may be formed integrally in the guide rail 22 as shown in FIGS. 2 and 3. Alternatively, as shown in FIGS. 4-9, a separate C-shaped rail 51 having a plurality of linearly-aligned holes 43 may be constructed and subsequently affixed to the counterweight guide rail 22. The rectangular holes 43 in the C-shaped rail 51 are configured for engagement with the drive gear 61. The smaller, round holes on rail 51 may be used as bolt holes for securing the C-shaped rail 51 to a counterweight guide rail which itself is not configured for engagement with the drive gear. The counterweight guide rail 22 also may include a restrictor guide rail that engages a pad system on the motor drive, as further discussed below.

In the discussion above, the counterweight guide rail 22 has been described as having linearly-aligned holes 43 for engagement with the drive gear 61. However, it is equally within the scope of the present invention that the holes are located on one or more of the car guide rails 7 and 7, or any other rail guides present in the elevator system, instead of on the counterweight guide rail 22, for engagement with the drive gear 61.

It is to be understood that a “hole” encompasses any structure, without limitation, in the longitudinal rail which can engage with the teeth of a gear or sprocket connected to the motor drive. The hole may be open, or it may be in the form of a recess, indentation, depression, or protruberance. The holes in the guide rail section can be formed by any means known in the art including, but not limited to, punching, stamping, or drilling from the guide rail section or a precursor structure. The shape of the holes or recesses will be determined by the requirement to engage with the teeth of a gear, sprocket, pinion or other mechanical element of the drive gear. The term “gear” is to be interpreted as any structure, without limitation, which is connected to the motor drive and which engages with the hole of the rail, such as a sprocket, cog, or flywheel.

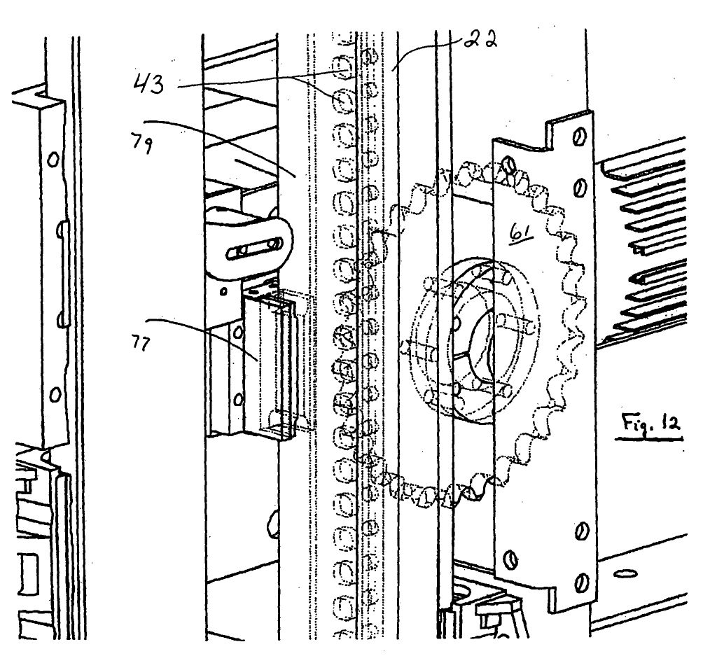

As shown in FIG. 10, a motor drive (machine) 30 comprising a motor 31 mounted within a frame 35 is installed adjacent to the counterweight guide rails 22 and above the pit channel module such that the output drive of the motor 31 is located adjacent to counterweight guide rail 22. A self-climbing drive gear 61 is mounted to the output drive of the motor 31, and is aligned to engage the holes 43 in the counterweight guide rail 22.

As shown in FIGS. 10 and 11, the machine frame 35 includes shoes 48 that can be used to guide the machine 30 up and down the counterweight guide rails 22 and 22′. A counterweight frame 70 is installed above the machine frame and also rides along counterweight guide rails 22 and 22′. During this phase of installation, referred to as self-climbing mode, the counterweight frame 70 is connected to the top of the machine to prevent the machine from ratcheting as it travels vertically along the counterweight guide rails.

Certain embodiments of the invention may comprise means for maintaining the gear in engagement with the holes of the rail. FIG. 12 shows an embodiment of a sliding restrictor pad configuration that may be employed to prevent the self-climbing drive gear 61 from backing out of the holes 43. A guide shoe machine mount assembly 77 comprising two opposing pads is mounted to the machine and slides along a restrictor guide rail 79. The guide shoe machine mount assembly pads can, for example, be composed of an ultra-high molecular weight synthetic polymer that can slide vertically along the restrictor guide rail 79. The assembly 77, however, laterally restricts the self-climbing gear 61 from backing out of the holes 43 in the counterweight guide rail 22.

The operation of the claimed invention will now be described. After the components for the lowest level of the elevator support structure are installed upon the foundation, the motor drive 30 is powered on. The teeth of the drive gear 61 engage the holes 43 in counterweight guide rail 22 and the machine begins to climb along the counterweight guide rails 22 and 22′. As discussed above, the shoes 48 on the machine frame 35 guide the machine 30 along the counterweight guide rails 22 and 22′, and the guide shoe machine mount assembly 77 prevents the machine from disengaging from holes 43 in guide rail 22. As illustrated in FIG. 13, when the motor drive 30 rises, so do the car sling 80 and the temporary platform 91.

Once the temporary platform 91 is raised to an appropriate height, the next section of car guide rails (7 and 7′) and counterweight guide rails (22 and 22′) can then be installed. Because the lower section is completely installed and optionally further stabilized with rail-spanning brackets 10 and 25, an installer can operate and work from the elevated temporary platform to lift the equipment and parts needed to build the next higher section of the elevator. Installation continues until the elevator guide rails and support structure reach the required height, at which time a header module is mounted to the top of the elevator support structure. To complete the installation of the elevator system, the machine mount tool plate bracket 93 is removed and the machine 30 is returned to its position at the bottom of the hoistway, where it can be affixed to the pit channel module 16, or replaced with another motor drive. If the motor drive is not replaced, the drive gear 61 is removed from the output of the motor drive 31, and the motor drive 31 is configured for engagement with an elevator support rope, for example, by providing the output of the motor drive with at least one traction sheave.

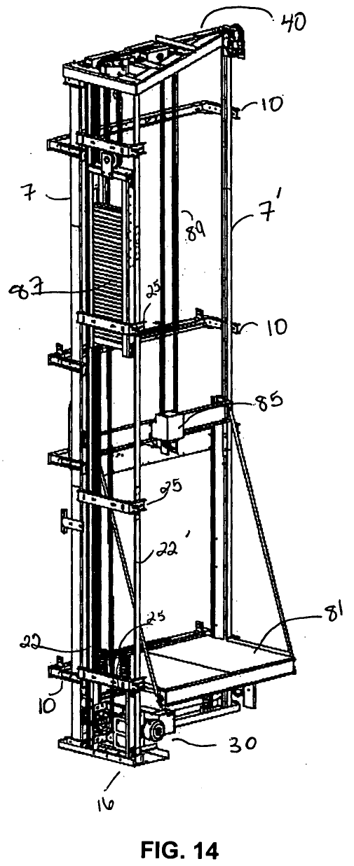

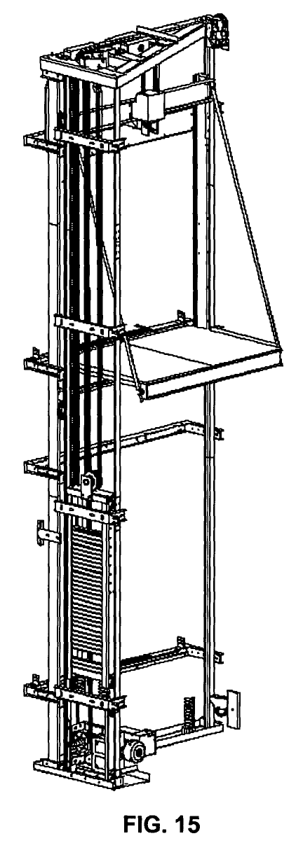

A traction elevator system comprising the elevator support structure of the invention is completed by installing an elevator car assembly, an elevator counterweight assembly, and a support rope in the elevator shaft, and operably linking these elements to a motor drive, which may or may not be the same motor drive used during self-climbing mode during installation. An embodiment of completed elevator system according to the present invention is illustrated in FIGS. 14 and 15.

As seen in FIGS. 14 and 15, the header module 40 affixed to the top of the support structure generally comprises one or more suspension sheaves, and the support rope 89 passes over the suspension sheave(s) to support the elevator car assembly 81 and the counterweight assembly 87. The rope 89 is driven by the motor drive 31 to move the elevator car assembly 81 and the counterweight assembly 87 within the hoistway.

In FIGS. 14 and 15, the elevator car assembly is mounted to slide along the car guide rails and has a front portion with guide shoes slidably coupled to the car guide rails 7 and 7′. Similarly, the counterweight assembly 87 is mounted to slide along the counterweight guide rails 22 and 22′ and has guide shoes slidably coupled to the counterweight guide rails 22 and 22′. The elevator car assembly 81 can be of a car sling type. The elevator car assembly 81 can comprise a pick-up point assembly 85 located above the center of mass of the elevator car assembly 81 for engagement with the support rope 89. The pick-up point assembly 85 may comprise a sheave for engagement with the support rope 89.

The motor drive 30 may be affixed to the pit channel module 16 or directly to the foundation of the building. The motor drive 30 can comprise a drive sheave for frictionally engaging the rope 89, or the motor drive 30 can directly drive the rope 89. In either case, the motor drive 30 moves the rope 89, which in turn displaces the elevator car or sling 81 and counterweight 87. As discussed previously, the motor drive 30 used to drive the support rope 89 may be the same motor drive used during self-climbing mode, or it may be a different motor drive.

The rope 89 of an elevator system constructed according to the invention may be formed from any suitable material known in the art, including, but not limited, metals such as steel, and synthetic materials such as aramid fiber ropes. The ropes may be sheathed to increase friction, for example, nylon-jacketed aramid fiber ropes. In addition, the rope may comprise different types of suspension members, such as chains and flat belts.

It is important that the pit channel module 16 be installed in a level position so that the guide rails 22 and 7 will be oriented vertically and that the header module 40 will be located directly above the pit channel module 16. If the foundation is uneven and/or not level, the pit channel module 16 can be secured in a level position slightly above the foundation, and an unhardened, hardening structural material can be introduced between and around the foundation and the pit channel module 16 to fill in any gaps or uneven areas. The unhardened structural material is then allowed to harden, thereby providing a strong and level footing for the pit channel module 16, with or without the use of additional fasteners. The pit channel module 16 may optionally have holes for receiving and interlocking the pit channel module 16 with the hardened structural material.

In the figures, the car guide rails 7 and 7′ and the counterweight guide rails 22 and 22′ have been shown in a triangular arrangement. In this regard, elevator support structures and elevator systems according to the present invention can comprise any of the triangulated elevator support structures and elevator systems disclosed in copending U.S. application Ser. No. 10/353,173, filed Jan. 28, 2003, which is herein incorporated by reference in its entirety. However, it is to be understood that the rail guides in the present invention are not limited to any particular geometric configuration and thus, for example, elevator support structures and elevator systems having a rectangular rail arrangement are also within the scope of present invention.

The dimensions, examples, and embodiments described herein are understood to be illustrative of the invention and not limiting of its scope. It will be understood that such descriptions are only exemplary. Many modifications and variations of the invention which are within its scope will be apparent to those skilled in the art. Accordingly, the scope of the invention is to be determined in connection with the appended claims and their equivalents.

What is claimed is:

1. A work structure for constructing a modular elevator support structure for an elevator system, comprising:
a pit channel module;
a plurality of vertical modular guide rails, one end of each guide rail attached to the pit channel module and the other end connectable in an end-to-end manner with additional guide rails or a header module, wherein at least one preselected modular guide rail has a plurality of holes linearly aligned along its longitudinal axis; and
a platform slidably coupled to the preselected guide rail and connected to a motor drive having a gear, the gear having teeth which are sized and configured to engage with the holes of the preselected guide rail,
wherein operating the motor drive causes the teeth of the gear to engage the holes of the preselected guide rail and thereby raise or lower the platform along the vertical guide rails.

2. The work structure of claim 1, wherein the holes are formed in the preselected guide rail, or are formed on a longitudinal rail fastened to the preselected guide rail.

3. The work structure of claim 1, further comprising means for maintaining the gear in engagement with the holes of the preselected guide rail.

4. The work structure of claim 1, wherein the modular guide rails are counterweight guide rails, elevator car guide rails, or combinations thereof.

5. A modular elevator support structure comprising:
a pit channel module;
a header module; and
a plurality of vertical guide rails, each guide rail comprising at least two end-to-end modular sections, wherein:
a lower end of each of a first subset of the plurality of guide rails is attached to the pit channel module, and another end of each of a second subset of the plurality of guide rails is attached to the header module, and
at least one preselected guide rail has holes aligned along its longitudinal axis.

6. The modular elevator support structure of claim 5, further comprising a platform slidably coupled to at least one guide rail and connected to a motor drive having a gear, the gear having teeth which are sized and configured to engage with the holes of the preselected guide rail, wherein operating the motor drive causes the teeth of the gear to engage the holes of the preselected guide rail and to thereby raise or lower the platform along the vertical guide rail.

7. The modular elevator support structure of claim 5, further comprising at least one horizontally-oriented bracket attached to at least two neighboring vertical guide rails.

8. The modular elevator support structure of claim 5, wherein
the support structure is configured to support a traction elevator, and
the plurality of vertical guide rails comprise at least two counterweight guide rails and at least two elevator car guide rails.

9. The modular elevator support structure of claim 5, wherein the preselected guide rail is a counterweight guide rail.

10. The modular elevator support structure of claim 5, wherein the preselected guide rail is an elevator car guide rail.

11. The modular elevator support structure of claim 5, wherein the holes are formed in the preselected guide rail, or are formed on a longitudinal rail secured to the preselected guide rail.

12. The elevator support structure of claim 6, further comprising means for maintaining the gear in engagement with the holes of the preselected guide rail.

13. A method of erecting an elevator support structure for a traction elevator system, comprising the steps of:
providing a pit channel module on a foundation;
providing a plurality of modular guide rail sections, each guide rail section having two ends;
connecting the first end of each of a preselected number of guide rail sections to the pit channel module to form a first level of guide rail sections, the second end of each of the predetermined number of guide rail sections being connectable in an end-to-end manner with additional guide rail sections,
wherein at least one preselected guide rail section of the first level has a plurality of holes aligned along its longitudinal axis;
slidably coupling a platform to at least one guide rail section, and connecting the platform to a motor drive having a gear, the gear sized and configured to engage with the holes of the preselected guide rail section;
operating the motor drive to engage the holes of the preselected guide rail section and thereby causing the platform to be raised or lowered along the guide rail section; and
installing a header module or additional guide rail sections to form an additional level of guide rail sections.

14. The method of claim 13, wherein the additional level of guide rail sections comprises at least one additional preselected rail section having holes for progressively raising the platform for installation of at least one subsequent level of guide rails or the header module.

15. A method of erecting a rope-driven elevator system comprising the steps of:
providing a pit channel module on a foundation;
providing a plurality of modular guide rail sections, each guide rail section having two ends;
connecting the first end of the plurality of guide rail sections to the pit channel module to form a first level of guide rail sections, the second end of each of the guide rail sections being connectable in an end-to-end manner with additional guide rail sections,
wherein at least one preselected guide rail section of the first level has a plurality of holes aligned along its longitudinal axis;
slidably coupling a platform to at least one guide rail section, and connecting the platform to a first motor drive having a gear, the gear sized and configured to engage with the holes of the preselected guide rail section;
operating the first motor drive to engage the holes of the preselected guide rail section and thereby causing the platform to be raised or lowered along the guide rail section;
installing at least one additional level of guide rail sections and the header module to form an elevator support structure;
securing a second motor drive to the elevator support structure or to the foundation, the second motor drive having a support rope-engagement drive member;
installing an elevator car, an elevator support rope and an elevator counterweight in the elevator support structure in an operably linked manner with the support rope-engagement member such that the car and counterweight are vertically displaceable within the elevator support structure by operation of the second motor drive.

16. The method of claim 15, wherein the first motor drive and the second motor drive are the same or different.

17. The method of claim 15, wherein the elevator system comprises means for maintaining the gear in engagement with the holes of the preselected guide rail section during installation.
